(19) United States
(12) Patent Application Publication
(10) Pub. No.: US 2006/0106149 A1
(43) Pub. Date: May 18, 2006

(54) Preparation of natural rubber-rich composition and tire with tread thereof

(76) Inventors: Paul Harry Sandstrom, Cuyahoga Falls, OH (US); Roger Neil Beers, Uniontown, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/992,054

(22) Filed: Nov. 18, 2004

(51) Int. Cl. C08K 3/34

(52) U.S. Cl. 524/493; 524/82; 523/209; 525/332.1; 526/175

(57) ABSTRACT

This invention relates to the preparation of a natural rubber-rich rubber composition and tire with tread thereof wherein a portion of the natural rubber is replaced with an inclusion of a specialized trans 1,4-styrene/butadiene copolymer rubber. The process involves preparing a pre-formed masterbatch of a first phase.

### FIELD OF THE INVENTION

This invention relates to the preparation of a natural rubber-rich rubber composition and tire with tread thereof. The process of partial replacement of the natural rubber in the natural rubber-rich tire tread is accomplished by an inclusion of a specialized trans 1,4-styrene/butadiene copolymer rubber by a process involving a sequential addition of the natural rubber to form two (dual) elastomer phases in the natural rubber-rich rubber composition. In the practice of the invention, only a portion of the natural rubber is initially mixed with the specialized trans 1,4-styrene/butadiene copolymer rubber and at least a portion of reinforcing filler to form a pre-formed masterbatch, or pre-mix, thereof and a first phase of the natural rubber-rich rubber composition. The addition of the remainder of the natural rubber is thereby delayed, and optionally an addition of a portion of reinforcing filler is thereby delayed, by the blending thereof to said pre-formed masterbatch to form a second phase of the natural rubber-rich rubber composition. In practice, the natural rubber remains a major portion of the elastomers in the tread rubber composition even though, optionally, a minor amount of at least one additional conjugated diene-based elastomer may be included in the blend. The specialized trans 1,4-styrene/butadiene rubber has a bound styrene content in a range of from about 5 to about 40, alternately about 15 to about 30, percent together with a microstructure of its polybutadiene portion composed of from about 50 to about 80 percent trans 1,4-isomeric units, from about 10 to about 20 percent cis 1,4-isomeric units and from about 2 to about 10 percent vinyl 1,2-isomeric units; and preferably has a Mooney (ML1+4) at 100° C. viscosity value in a range of from about 50 to about 100, alternately from about 50 to about 85, and preferably has a glass transition temperature (Tg) in a range of from about −60° C. to about −90° C.

### BACKGROUND OF THE INVENTION

A challenge is presented of replacing a portion of natural cis 1,4-polyisoprene rubber with a synthetic polymer, or elastomer, in a natural rubber-rich tire tread rubber composition to achieve a rubber composition of similar physical properties. A motivation for such challenge is a desire for a natural rubber alternative, at least a partial alternative, in a form of a synthetic rubber to offset relative availability and/or cost considerations of natural rubber.

Therefore, such challenge has been undertaken to evaluate the feasibility of replacing a portion of natural rubber in a tire tread (for rubber treads which contain a significant amount of natural rubber such as treads for heavy duty tires) with a synthetic rubber.

A simple partial substitution of a synthetic elastomer for a portion of the natural rubber contained in a natural rubber-rich tire tread rubber composition which contains a significant natural rubber content is not considered herein to be a normal feasible alternative where it is desired to achieve a rubber composition with physical properties similar to the unsubstituted natural rubber-rich rubber composition.

It is considered herein that a significant consideration for the synthetic elastomer to be used as a candidate for partial substitution for the natural rubber in a natural rubber-rich rubber composition for a tire tread to have a suitable tear strength property of the rubber composition similar to the tear strength of the natural rubber-rich rubber composition itself. It is considered herein that such resultant comparative tear strength property of the rubber composition is a significant physical property for considering a specialized high trans 1,4-styrene/butadiene copolymer elastomer as a candidate for such partial substitution.

Accordingly, in a preferred practice of this invention, a partial substitution of a specialized high trans 1,4-styrene/butadiene copolymer elastomer for the natural rubber is accomplished by a process of incremental, delayed mixing of a portion of the natural rubber with the specialized trans 1,4-styrene/butadiene copolymer elastomer, together with at least a portion of reinforcing filler, to form a masterbatch (or pre-mix) thereof followed by mixing the remainder of the natural rubber with the masterbatch together with the remainder, if any, of reinforcing filler.

In practice, a suitable tear strength property of a rubber composition at 23° C. or 95° C. is often desired to promote, or enhance, chip-chunk resistance of a tire tread.

In practice, pneumatic rubber tires conventionally have rubber treads which contain a running surface of the tire intended to be ground contacting. Such tire treads are subject, under operating conditions, to considerable dynamic distortion and flexing, abrasion due to scuffing, fatigue cracking and weathering such as, for example, atmospheric aging.

Tires, particularly large tires such as for example, large off-the-road, truck, agricultural tractor, as well as aircraft tires, which are intended to be subject to heavy loads and inherent tendency of internal heat build up and associated high temperature operation, generally contain a significant natural cis 1,4-polyisoprene rubber content, because of, for example, the well known heat durability of the natural rubber as compared to synthetic diene based elastomers in general. Such tires may have a tread which is of a natural rubber-rich rubber composition, namely which contains more than 50 phr of natural rubber.

Significant physical properties for the natural rubber-rich tire tread rubber compositions are considered herein to be Rebound (at 100° C.) and tan delta (at 100° C.) which contribute to rolling resistance of the tire and therefore fuel economy of the associated vehicle, with higher values being desired for the rebound property and lower values being desired for the tan delta property.

Additional desirable physical properties are considered herein to be higher low strain stiffness properties, in combination with the above rebound and tan delta properties, as indicated by Shore A hardness values and G′ at 10 percent strain values at 100° C. to promote cornering coefficient and handling for the tire and resistance to tread wear.

Accordingly, it is readily seen that a process of partial substitution of a synthetic rubber for a portion of the natural rubber in a natural rubber-rich tread rubber composition is not a simple matter, and requires more than routine experimentation, where it is desired to substantially retain, or improve upon, a suitable balance of the representative physical properties of the natural rubber-rich tread rubber composition itself.

Indeed, it is considered herein that a process of preparing a tire tread rubber composition by substituting a synthetic rubber, particularly the specialized styrene/butadiene copolymer elastomer, for a portion of the natural rubber, by first forming a masterbatch (pre-mix) thereof in which only a portion of the natural rubber is mixed therewith followed by delaying the mixing of the remainder of the natural rubber with the masterbatch to form a dual phase rubber composition, is a significant departure from past practice.

Generally, it is appreciated that natural rubber-rich tire tread rubber compositions historically may also contain various amounts of one or more additional synthetic diene-based elastomers. Such additional synthetic diene based elastomers may include, for example, cis 1,4-polybutadiene rubber to enhance, for example, abrasion resistance and associated resistance to tread wear as well as styrene/butadiene copolymer elastomers to enhance, for example tread traction.

For example, preparation and use of trans 1,4-styrene/butadiene by a specified catalyst system has been described in U.S. Pat. No. 6,627,715.

Partial replacement of natural rubber with trans copolymers of isoprene and 1,3-butadiene has been suggested in U.S. Pat. No. 5,844,044.

However, for this invention, a tire tread, with running surface, is presented of a rubber composition which is comprised of a natural rubber-rich rubber composition in which a major rubber portion of its rubber content is natural cis 1,4-polyisoprene rubber and minor rubber portion is a specialized trans 1,4-styrene/butadiene rubber prepared by the aforesaid process of incremental addition of the natural rubber involving a formation of the aforesaid masterbatch.

In the practice of this invention, the process of incremental, delayed, addition of the natural rubber to the specialized trans 1,4-styrene/butadiene rubber has been observed herein to enable a partial replacement of the natural cis 1,4-polyisoprene rubber in natural rubber-rich tread compositions of relatively large tires which are designed to experience relatively large loads under working conditions with an associated internal heat generation.

For the description of this invention, a reference to glass transition temperature, or Tg, of an elastomer or sulfur vulcanizable polymer, particularly the specialized trans 1,4-styrene/polybutadiene polymer, represents the glass transition temperature of the respective elastomer or sulfur vulcanizable polymer in its uncured state. The Tg can be suitably determined by a differential scanning calorimeter (DSC) at a temperature rate of increase of 10° C. per minute, (ASTM 3418), a procedure well known to those having skill in such art.

A reference to melt point, or Tm, of a sulfur vulcanizable polymer, particularly the specialized trans 1,4-polybutadiene polymer, represents its melt point temperature in its uncured state, using basically the same or similar procedural method as for the Tg determination, using a temperature rate of increase of 10° C. per minute, a procedure understood by one having skill in such art.

A reference to molecular weight, such as a weight average molecular weight (Mw), or number average molecular weight (Mn), of an elastomer or sulfur vulcanizable polymer, particularly the specialized trans 1,4-styrene/butadiene polymer, represents the respective molecular weight of the respective elastomer or sulfur vulcanizable polymer in its uncured state. The molecular weight can be suitably determined by GPC (gel permeation chromatograph instrument) analysis, a procedural molecular weight determination well known to those having skill in such art.

A reference to Mooney (ML 1+4) viscosity of an elastomer or sulfur vulcanizable polymer, particularly the specialized trans 1,4-polybutadiene polymer, represents the viscosity of the respective elastomer or sulfur vulcanizable polymer in its uncured state. The Mooney (ML 1+4) viscosity at 100° C. relates to its “Mooney Large” viscosity, taken at 100° C. using a one minute warm up time and a four minute period of viscosity measurement, a procedural method well known to those having skill in such art.

In the description of this invention, the terms “compounded” rubber compositions and “compounds”, where used, refer to the respective rubber compositions which have been compounded with appropriate compounding ingredients such as, for example, carbon black, oil, stearic acid, zinc oxide, silica, wax, antidegradants, resin(s), sulfur and accelerator(s) and silica and silica coupler where appropriate. The terms “rubber” and “elastomer” may be used interchangeably. The terms “cure” and “vulcanize” may be used interchangeably unless otherwise indicated. The terms “compound” and “rubber composition” may be used interchangeably unless otherwise indicated. Reference to a high trans 1,4-styrene/butadiene copolymer elastomer may also be made herein more simply in terms of a polymer or copolymer. The amounts of materials are usually expressed in parts of material per 100 parts of rubber polymer by weight (phr) unless otherwise indicated.

Disclosure and Practice of the Invention

In accordance with this invention, a process of preparing a natural rubber-rich rubber composition, particularly for a tire tread component (containing a running surface for the tire and therefore intended to be ground contacting) comprised of the sequential mixing steps of, based upon parts by weight per 100 parts by weight rubber of said rubber composition (phr):

(A) blending in a preparatory mixing step, desirably in an internal rubber mixer and desirably to a temperature in a range of from about 140° C. to about 170° C., to form a masterbatch thereof:
(1) about 50 to about 90, alternately about 45 to about 85, phr of a total of from about 55 to about 98, alternately about 60 to about 95, phr of natural cis 1,4-polyisoprene rubber,
(2) about 2 to about 45, alternately about 5 to about 40, phr of specialized trans 1,4-styrene/butadiene copolymer elastomer, and
(3) about 25 to about 100 percent of a total of 30 to about 120 phr of particulate reinforcing filler, thereafter

(B) blending with said masterbatch in a subsequent additional preparatory mixing step, desirably in an internal mixer and desirably to a temperature in a range of from about 140° C. to about 170° C., to form a resultant mixture thereof,
(1) the remainder of said natural cis 1,4-polyisoprene rubber, and
(2) the remainder of said reinforcing filler, if any, and thereafter

(C) blending sulfur curative with said resultant mixture, desirably in an internal rubber mixer and desirably to a temperature in a range of from about 90° C. to about 120° C. to form a resultant rubber composition;

wherein said specialized styrene/butadiene copolymer elastomer has a bound styrene content in a range of from about 5 to about 40, alternately from 15 to 30, percent and a microstructure of its polybutadiene portion composed of from about 50 to about 80 percent trans 1,4-isomeric units, from about 10 to about 20 percent cis 1,4-isomeric units and from about 2 to about 10 percent vinyl 1,2-isomeric units;

wherein said particulate reinforcing filler is comprised of:
(1) about 5 to about 120, alternately from about 30 to about 115, phr of rubber reinforcing carbon black, and
(2) from zero to about 60, alternately from about 5 to about 60 and further alternately from about 5 to about 25, phr of amorphous synthetic silica, preferably precipitated silica (preferably together with a coupling agent for said precipitated silica having a moiety reactive with hydroxyl groups, e.g. silanol groups, on said precipitated silica and another different moiety interactive with said natural cis 1,4-polyisoprene rubber and said specialized styrene/butadiene copolymer elastomer as would be recognized by one having skill in such art.). In practice, as would be understood by one having skill in such art for an accepted practice, said masterbatch and said resultant mixture are desirably individually removed from their associated internal rubber mixer and cooled to a temperature below 50° C., preferably below 40° C. (e.g. preferably a temperature in a range of from about 10° C. to about 40° C., depending somewhat upon ambient conditions in the manufacturing work place) prior to the next sequential mixing step

In practice, said process may further comprise mixing a total of from zero to about 20, alternately about 5 to about 15, phr of at least one additional synthetic diene-based elastomer therewith as apportioned between said master batch and said resulting mixture, in at least one of said preparatory mixing steps, so long as said natural cis 1,4-polyisoprene rubber content of said rubber composition is at least 55 phr, selected from polymers of isoprene and/or 1,3-butadiene (in addition to said specialized trans 1,4-styrene/butadiene rubber) and copolymers of styrene together with isoprene and/or 1,3-butadiene.

In practice, said process further comprises sulfur curing said rubber composition, desirably at a temperature in a range of from about 135° C. to about 170° C.

In additional accordance with this invention, a rubber composition is provided as prepared by said method.

In practice, said process further comprises extruding said rubber composition through a rubber extruder to form an unvulcanized (and shaped) rubber tread strip, building said unvulcanized rubber strip onto an unvulcanized rubber tire carcass to form an assembly thereof and curing said assembly in a suitable mold (e.g. at a temperature in a range of from about 135° C. to about 170° C.) to form a tire.

In further accordance with this invention a tire is provided as prepared by said method.

It is considered herein that a significant aspect of process of this invention is the phase mixing of natural rubber, specialized styrene/butadiene copolymer elastomer and at least a portion of the reinforcing filler in which the mixing of a significant portion of the addition of the natural rubber is held back until the initial portion of the natural rubber and all of the specialized styrene/butadiene copolymer elastomer is first blended with a portion of the reinforcing filler to form a filler reinforced masterbatch thereof.

Thereafter, the remainder of the natural rubber is mixed with the masterbatch, alternatively with a remaining portion of the reinforcing filler, in a phase mixing procedure in a manner which is believed to be a significant departure from past practice.

Accordingly, the process of this invention is therefore considered as providing a process of preparing a dual phased rubber composition which comprises said process of first forming a first phase comprised of said masterbatch and thereafter forming a second phase comprised of blending said remaining natural cis 1,4-polyisoprene elastomer and said remaining reinforcing filler, if any, with said masterbatch.

In further accordance with this invention, a dual phased rubber composition is provided as being prepared by such process.

In such practice, for the process of this invention, a first phase of the rubber composition is prepared by said mixing, desirably in an internal rubber mixer, a portion of the natural rubber together with the specialized styrene/butadiene copolymer elastomer and reinforcing filler (e.g. rubber reinforcing carbon black and/or precipitated silica) to form said masterbatch of filler reinforced combination of natural rubber and said specialized styrene/butadiene copolymer elastomer and a first phase of said natural rubber-rich rubber composition which has a first-formed preferential affinity to said reinforcing filler.

The second phase of the natural rubber-rich rubber composition is formed by said thereafter blending, desirably in an internal rubber mixer, the remainder of the natural rubber and remainder, if any, of the reinforcing filler, with said masterbatch of natural rubber and said specialized styrene/butadiene elastomer to form said second elastomer phase which has a significant lesser affinity to said first added reinforcing filler in said masterbatch.

In practice, the reinforcing filler may be rubber reinforcing carbon black, precipitated silica or a combination thereof. If the process utilizes, for example, an addition of 50 percent of the reinforcing filler in the masterbatch-forming portion of the process and the remaining 50 percent of the reinforcing filler in the resulting mixture-forming portion of the process, then addition of the carbon black and/or silica of the reinforcing filler may be divided between the two portions of the process, to a degree in a manner desired.

Optionally, the reinforcing filler may also contain a silica-containing carbon black which contain domains of silica on its surface wherein the silica domains contain hydroxyl groups on their surfaces.

The silica (e.g. precipitated silica) is to be used in conjunction with a silica coupler to couple the silica to the elastomer(s), to thus enhance its effect as reinforcement for the elastomer composition. Use of silica couplers for such purpose are well known and typically have a moiety reactive with the silica and another moiety interactive with the elastomer(s) to create the silica-to-rubber coupling effect.

In practice, as hereinbefore indicated, the specialized trans 1,4-styrene/butadiene rubber preferably has a glass transition temperature (Tg) in a range of from about −60° C. to about −90° C., alternately from about −65° C. to about −85° C.

In practice, as hereinbefore indicated, the specialized trans 1,4-styrene/butadiene rubber preferably has a Mooney (ML 1+4), at 100° C., viscosity in a range of from about 50 to about 100, alternately from about 50 to about 85.

The specialized trans 1,4-styrene/butadiene rubber may be prepared, for example, by co-polymerization of styrene and 1,3-butadiene monomers in an organic solvent in the presence of a catalyst composite composed of the barium salt of di(ethylene glycol) ethylether (BaDEGEE), tri-n-octylaluminum (TOA) and n-butyl lithium (n-BuLi) in a molar ratio of the BaDEGEE to TOA to n-BuLi in a range of about 1:4:3, which is intended to be an approximate molar ratio, so long as the resulting trans 1,4-styrene/butadiene polymer is the said specialized trans 1,4-styrene/butadiene copolymer which is considered herein to not require undue experimentation by one having skill in such art. Optionally, an amine containing barium alkoxide, such as the barium salt of 2-N,N-dimethyl amino ethoxy ethanol (Ba-N,N-DMEE) can be used in place of BaDEGEE so long as the specialized copolymer is produced. The approximate molar ratio of the barium salt of 2-N,N-dimethyl amino ethoxy ethanol (Ba-N,N-DMEE), tri-n-octylaluminum (TOA) and n-butyl lithium (n-BuLi) in a molar ratio of the Ba-N,N-DMEE to TOA to n-BuLi is in a range of about 1:4:3. This catalyst system using the amine containing barium alkoxide, Ba-N,N-DMEE, was described previously in U.S. Pat. No. 6,627,715.

For example, the catalyst composite may be composed of about 7.2 ml of about a 0.29 M solution of the barium salt of di(ethylene glycol) ethylether (BaDEGEE) in suitable solvent such as, for example, ethylbenzene, about 16.8 ml of about a 1 M solution of tri-n-octylaluminum (TOA) in a suitable solvent such as, for example, hexane and about 7.9 ml of about a 1.6 M solution of n-butyl lithium (n-BuLi) in a suitable solvent such as, for example, hexane. The molar ratio of the three catalyst components, namely the BaDEGEE to TOA to n-BuLi may be, for example, said about 1:4:3.

As disclosed in U.S. Pat. No. 6,627,715, a four component catalyst system which consists of the barium salt of di(ethylene glycol) ethylether (BaDEGEE), amine, the tri-n-ocytylaluminum (TOA) and the n-butyl lithium (n-BuLi) may also be used to prepare high trans 1,4-styrene/butadiene polymers for use as a partial replacement of natural rubber in a natural rubber-rich tread rubber composition. The molar ratio of the BaDEGEE, to amine to TOA to n-BuLi catalyst components is about 1:1:4:3, which is intended to be an approximate ratio in which the amine can be a primary, secondary or tertiary amine and may be a cyclic, acyclic, aromatic or aliphatic amine, with exemplary amines being, for example, n-butyl amine, isobutyl amine, tert-butyl amine, pyrrolidine, piperidine and TMEDA (N,N,N′,N′-tetramethylethylenediamine, preferably pyrrolidine, so long as the resulting trans 1,4-styrene/butadiene polymer is the said specialized trans 1,4-styrene/butadiene copolymer which is considered herein to not require undue experimentation by one having skill in such art.

In one aspect, the catalyst composite may be pre-formed prior to introduction to the 1,3-butadiene monomer or may be formed in situ by separate addition, or introduction, of the catalyst components to the 1,3-butadiene monomer so long as the resulting trans 1,4-styrene/butadiene polymer is the aforesaid specialized trans 1,4-styrene/butadiene polymer. The pre-formed catalyst composite may, for example, be a tri-component pre-formed composite comprised of all three of the BaDEGEE, TOA and BuLi components prior to introduction to the 1,3-butadiene monomer or may be comprised of a dual pre-formed component composite comprised of the BaDEGEE and TOA components to which the n-BuLi component is added prior to introduction o the 1,3-butadiene monomer.

In one aspect, the organic solvent polymerization may be conducted as a batch or as a continuous polymerization process. Batch polymerization and continuous polymerization processes are, in general, well known to those having skill in such art.

As hereinbefore mentioned, a coupling agent may, if desired, be utilized with the silica to aid in its reinforcement of the rubber composition which contains the silica. Such coupling agent conventionally contains a moiety reactive with hydroxyl groups on the silica (e.g. precipitated silica) and another and different moiety interactive with the diene hydrocarbon based elastomers, particularly the natural cis 1,4-polyisoprene rubber and specialized styrene/butadiene copolymer elastomer.

The hereinbefore referenced silica coupling agent might be, for example, a bis(3-trialkoxysilylalkyl) polysulfide which contains from two to about 8 sulfur atoms, usually an average of from about 2.3 to about 4, sulfur atoms in its polysulfidic bridge. The alkyl groups may be selected, for example, from methyl, ethyl and propyl radicals. Exemplary of such coupler might be, for example, bis-(3-triethoxysilylpropyl) polysulfide.

If desired, said hereinbefore referenced silica coupling agent may be, for example, an alkoxyorganomercaptosilane, particularly a capped alkoxyorganomercaptosilane having its mercapto moiety capped.

Representative of additional synthetic diene based elastomers for said tread rubber composition are, for example, synthetic cis 1,4-polyisoprene rubber, cis 1,4-polybutadiene rubber, styrene/butadiene copolymer rubber, isoprene/butadiene copolymer rubber, styrene/isoprene/butadiene terpolymer rubber, and 3,4-polyisoprene rubber.

It is readily understood by those having skill in the art that the rubber compositions would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur-vulcanized material (rubbers), the additives mentioned above are selected and commonly used in conventional amounts.

Typical additions of reinforcing carbon black have been hereinbefore discussed. Typical amounts of tackifier resins, if used, may comprise about 0.5 to about 10 phr, usually about 1 to about 5 phr. Typical amounts of processing aids may comprise 1 to 20 phr. Such processing aids can include, for example, aromatic, napthenic, and/or paraffinic processing oils. Silica, if used, has been hereinbefore discussed. Typical amounts of antioxidants comprise about 1 to about 5 phr. Representative antioxidants may be, for example, diphenyl-p-phenylenediamine and others, such as, for example, those disclosed in the Vanderbilt Rubber Handbook (1978), pages 344-346. Typical amounts of antiozonants comprise about 1 to about 5 phr. Typical amounts of fatty acids, if used, which can include stearic acid comprise about 0.5 to about 3 phr. Typical amounts of zinc oxide comprise about 2 to about 6 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide. The presence and relative amounts of the above additives are considered to be not an aspect of the present invention which is more primarily directed to natural rubber-rich compositions and tires having treads thereof.

The vulcanization is conducted in the presence of a sulfur-vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur-vulcanizing agent is elemental sulfur. As known to those skilled in the art, sulfur-vulcanizing agents are used in an amount ranging from about 0.5 to about 4 phr, with a range of from about 0.5 to about 2.25 being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.0 phr. In another embodiment, combinations of two or more accelerators in which the primary accelerator is generally used in the larger amount (0.5 to 2 phr), and a secondary accelerator which is generally used in smaller amounts (0.05 to 0.50 phr) in order to activate and to improve the properties of the vulcanizate. Combinations of these accelerators have been known to produce a synergistic effect on the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound. The presence and relative amounts of sulfur vulcanizing agent and accelerator(s) are not considered to be an aspect of this invention which is more primarily directed to the specified blends of elastomers for natural rubber-rich rubber compositions for tire treads.

Sometimes, the combination of zinc oxide, fatty acid, sulfur and accelerator(s) may be collectively referred to as curatives.

Sometimes a combination of antioxidants, antiozonants and waxes may be collectively referred to as antidegradants.

The tire can be built, shaped, molded and cured by various methods which will be readily apparent to those having skill in such art.

The invention may be better understood by reference to the following example in which the parts and percentages are by weight unless otherwise indicated.

### EXAMPLE I

### Preparation of High Trans Styrene-Butadiene Copolymer by a Preformed Catalyst

This example represents an example of preparation of specialized high trans 1,4-styrene/butadiene copolymer having a bound styrene content of about 26.7 percent with a preformed catalyst. The specialized high trans 1,4-styrene/butadiene copolymer is referred herein as polymer Sample A.

The catalyst system was composed of barium salt of di(ethylene glycol) ethylether (BaDEGEE), tri-n-octylaluminum (TOA) and n-butyllithium (n-BuLi). A detailed description of the catalyst system is disclosed in U.S. Pat. No. 6,627,715.

An exemplary preparation of the preformed catalyst is accomplished by reacting 20 ml of 0.9 M barium salt of di(ethylene glycol) ethylether (BaDEGEE) in ethylbenzene solvent with 72 ml of 1 M trioctylaluminum (TOA) in hexane solvent. The resulting catalyst mixture is heat aged at 70° C. for about 30 minutes to form a pre-alkylated barium compound. Upon cooling to ambient temperature, 33.8 ml of 1.6 M n-butyllithium (n-BuLi) is added to the pre-alkylated barium compound to form a preformed catalyst for making trans styrene/butadiene copolymer. The molar ratio of BaDEGEE to TOA and to n-BuLi is 1:4:3. The molarity of the preformed catalyst is about 0.143M in barium. This preformed catalyst composite can be used for making a high trans styrene-butadiene copolymer directly with or without additional heat aging at 70° C.

The co-polymerization of styrene and 1,3-butadiene monomers may be carried, for example, at about 90° C. for about 3.5 hours. Neat ethanol may be added to shortstop the polymerization. The recovered polymer may be dried, for example, in a vacuum oven at about 50° C.

The following Table 1 represents a summary of the microstructure and various properties of the specialized high trans 1,4-styrene/butadiene copolymer Sample A.

TABLE 1

| Properties | Sample A |
|---|---|
| Microstructure, Specialized Trans | |
| 1,4-Styrene/Butadiene Copolymer | |
| Styrene Content (weight percent) | 26.7 |
| Trans 1,4-Polybutadiene content (wt %) | 57.5 |
| Cis 1,4-Polybutadiene content (wt %) | 12.0 |
| Vinyl 1,2-Polybutadiene content (wt %) | 3.8 |
| Physical Properties, Specialized Trans | |
| 1,4-Styrene/Butadiene Copolymer | |
| Mooney (1 + ML4) (100° C.) viscosity | 62 |
| Tg (onset) (° C.) | −69.7 |
| Mn (10³) | 145.9 |
| Mw (10³) | 481.6 |
| HI (heterogeniety index) (Mw/Mn) | 3.3 |

### EXAMPLE II

### Preparation of Natural Rubber-Rich Rubber Compositions

Samples of natural rubber-rich rubber compositions were prepared in internal rubber mixers.

A comparative natural rubber-rich rubber composition is referred to herein as Comparative Sample C-1 which does not contain the specialized trans 1,4-styrene/butadiene elastomer.

An additional comparative natural rubber-rich composition is referred to herein as Control Sample C-2 in which a portion of the natural rubber is replaced with the specialized high trans 1,4-styrene/butadiene copolymer Sample A of Example I by mixing all of the two elastomers together in the same mixing step.

Experimental natural rubber-rich rubber compositions are prepared similar to Control Sample C-2 except that a phase mixing process is used in which a masterbatch is first prepared by blending, in an internal rubber mixer, various amounts of the natural rubber with the specialized trans 1,4-styrene/butadiene elastomer, together with reinforcing carbon black filler, and a resulting mixture is then prepared by the delayed addition of the remainder of the natural rubber and carbon black reinforcing filler. The experimental interrupted and proportional delay of addition of the natural rubber and reinforcing carbon black filler preparations are referred to as Samples E-1, E-2 and E-3.

For the preparation of comparative rubber composition the respective Comparative Sample C-1 and Control C-2, the elastomer(s) was/were were mixed with reinforcing fillers and other rubber compounding ingredients in a first non-productive mixing stage (NP1) in an internal rubber mixer for about 4 minutes to a temperature of about 160° C. The resulting mixture is then subsequently mixed in a second non-productive mixing stage (NP2) in an internal rubber mixer for about 2 minutes to a temperature of about 160° C. without addition of reinforcing filler or additional elastomer. The resulting mixture from the two sequential non-productive mixing steps is then mixed in a productive mixing step, or stage, (P) in an internal rubber mixer with curatives for about 2 minutes to a temperature of about 110° C. The rubber composition is cooled to below 40° C. between each of the non-productive mixing steps and between the second non-productive mixing step and the productive mixing step.

Experimental rubber composition Samples E-1, E-2 and E-3 were prepared by mixing the elastomers together with reinforcing fillers and other rubber compounding ingredients in a first non-productive mixing stage (NP1) in an internal rubber mixer for about 4 minutes to a temperature of about 160° C., wherein only a portion of the natural rubber of the recipe is added. The mixture is subsequently mixed in a second non-productive mixing stage (NP2) in an internal rubber mixer for about 2 minutes to a temperature of about 160° C. wherein the remainder of the natural rubber of the recipe is added. The resulting mixture is then mixed in a productive mixing step, or stage, (P) in an internal rubber mixer with curatives for about 2 minutes to a temperature of about 110° C. The rubber composition is cooled to below 40° C. between each of the non-productive mixing steps and between the second non-productive mixing step and the productive mixing step.

The basic recipe for the rubber composition Comparative Sample C-1 and Control Sample C-2 and experimental Samples E-1, E-2 and E-3 is presented in the following Table 2.

TABLE 2

| | Parts by |
|---|---|
| | Weight (phr) |
| First Non-Productive Mixing Step (NP1) | |
| Natural cis 1,4-polyisoprene rubber, TSR20 | 45, 55, 65, |
| | 75 or 100 |
| Specialized trans 1,4-styrene/butadiene copolymer rubber¹ | 25 or 0 |
| Carbon black² | 40 |
| Wax and Fatty acid³ | 3.5 |
| Zinc oxide | 4 |
| Second Non-Productive Mixing Step (NP2) | |
| Natural cis 1,4-polyisoprene rubber, (TSR20) | 0, 10, 20 |
| | or 30 |
| Carbon black² | 13 |
| Antioxidants⁴ | 3.5 |
| Productive Mixing Step (P) | |
| Sulfur | 1.0 |
| Accelerator⁵ | 1.5 |
| Retarder⁶ | 0.35 |
| Antioxidant⁴ | 0.5 |

¹Specialized high trans 1,4-styrene/butadiene copolymer Sample A, (Example I)
²N121, an ASTM designation for the carbon black
³Microcrystalline and paraffinic wax as processing aids and industrial grade stearic acid as a blend comprised of stearic, palmitic and oleic fatty acids
⁴Quinoline and amine type of antioxidants
⁵Tertiary butyl sulfenamide sulfur vulcanization accelerator
⁶Phtalimide type sulfur vulcanization retarder

The following Table 3 illustrates cure behavior and various physical properties of the natural rubber-rich rubber composition Comparative Sample C-1 and Control C-2 and Experimental Samples E-1, E-2 and E-3. Where cured rubber samples are evaluated, such as for the stress-strain, rebound, hardness and tear strength properties, the rubber samples were cured for about 32 minutes at a temperature of about 150° C.

TABLE 3

| | Comparative Control | | | | |
|---|---|---|---|---|---|
| Sample | C-1 | C-2 | E-1 | E-2 | E-3 |
| Rubber Compound (Cpd) | | | | | |
| Natural cis 1,4-polyisoprene rubber (NP1) | 100 | 75 | 65 | 55 | 45 |
| Trans 1,4-styrene/butadiene rubber | 0 | 25 | 25 | 25 | 25 |
| Natural cis 1,4-polyisoprene rubber (NP2) | 0 | 0 | 10 | 20 | 30 |
| Rheometer, 150° C. (MDR)¹ | | | | | |
| Maximum torque (dNm) | 18.95 | 18.48 | 17.95 | 18.3 | 18.84 |
| Minimum torque (dNm) | 3.17 | 3.82 | 3.42 | 3.73 | 4.05 |
| Delta torque (dNm) | 15.78 | 14.66 | 14.53 | 14.57 | 14.79 |
| T90, minutes | 14.6 | 17.6 | 17.4 | 17.2 | 16.8 |
| Stress-strain (ATS)² | | | | | |
| Tensile strength (MPa) | 24.4 | 24.8 | 24.2 | 22.8 | 23.7 |
| Elongation at break (%) | 494 | 542 | 532 | 506 | 514 |
| 300% modulus (MPa) | 12.5 | 11.1 | 11 | 11.1 | 11.4 |
| Rebound | | | | | |
| 23° C. | 40 | 38 | 38 | 38 | 38 |
| 100° C. | 53 | 51 | 51 | 50 | 51 |
| Hardness (Shore A) | | | | | |
| 23° C. | 70 | 71 | 71 | 71 | 72 |
| 100° C. | 59 | 59 | 60 | 60 | 61 |
| Tear strength, N³ | | | | | |
| 23° C.³ | 501 | 519 | 525 | 540 | 501 |
| 95° C. | 221 | 229 | 253 | 234 | 208 |
| RPA, 100° C., 1 Hz⁴ | | | | | |
| G′ at 10% strain (kPa) | 1474 | 1457 | 1483 | 1462 | 1515 |
| Tan delta at 10% strain | 0.165 | 0.187 | 0.175 | 0.184 | 0.182 |
| ¹Data obtained according to Moving Die Rheometer instrument, model MDR-2000 by Alpha Technologies, used for determining cure characteristics of elastomeric materials, such as for example Torque, T90 etc. | | | | | |
| ²Data obtained according to Automated Testing System instrument by the Instron Corporation which incorporates six tests in one system. Such instrument may determine ultimate tensile, ultimate elongation, | | | | | |
| # modulii, etc. Data reported in the Table is generated by running the | | | | | |
| # ring tensile test station which is an Instron 4201 load frame. | | | | | |
| ³Data obtained according to a peel strength adhesion (tear strength) test to determine interfacial adhesion between two samples of a rubber composition. In particular, such interfacial adhesion is determined by pulling one rubber composition away from the other at a right | | | | | |
| # angle to the untorn test specimen with the two ends of the rubber compositions being pulled apart at a 180° angle to each other using an Instron instrument. The area of contact at the interface between the rubber samples is facilitated by placement of a plastic film (e.g. | | | | | |
| # Mylar ™ film) between the samples with | | | | | |
| # a cut-out window in the film to enable the two rubber samples to contact each other following which the samples are vulcanized together and the resultant composite of the two rubber compositions used for the peel strength (tear strength) test. For example, an uncured rubber sample | | | | | |
| # is prepared by milling the rubber composition and applying a suitable removable film (e.g. a polyethylene film) to each of the two sides of the milled rubber. Two uncured rubber samples are cut from the milled rubber composition into a size 150 × 150 × 2.4 | | | | | |
| # mm thickness. The polyethylene film is removed from one side of a first sample and a fabric backing (e.g. polyester cord fabric) is stitched to that side with a roller in order to provide dimensional stability for the rubber sample. The polyethylene film is removed from the other | | | | | |
| # side of the first sample and a separator sheet of the Mylar film (with a 5 mm wide × 50 mm long | | | | | |
| # cut out window) is placed and centered on the exposed rubber surface of the sample. The polyethylene film is removed from one side of the second sample. The first and second samples are pressed together with the Mylar film therebetween and stitched together with a roller in a manner | | | | | |
| # that the window in the Mylar film allows the samples to contact each other. The composite of the two samples is placed in the bottom cavity of a preheated diaphram based curing mold. The composite is covered with a sheet of cellophane film. An expandable bladder is positioned onto | | | | | |
| # the cellophane film within the mold and a | | | | | |
| # metal top cover is positioned over the curing bladder to form an assembly thereof, all within the mold. The mold which contains the assembly is placed in a preheated curing press. The press is closed over the mold and an air pressure of 6.9 bar (100 psi) is applied to the expandable | | | | | |
| # bladder with the curing mold through an air line fixture on the curing mold. A cure temperature of 150° C. is used. After curing for about 32 minutes, the air line to the mold is shut off, the mold removed from the press, followed by removal of the top plate, bladder. The composite | | | | | |
| # is removed from the mold and allowed to cool to about 23° C. and the cellophane removed. From the cured composite, 25 mm (1 inch) test strips are cut so that the included Mylar film, with its aforesaid window, is located as near to the middle of the test strip as reasonably | | | | | |
| # possible. A portion of the first and second samples at an open end of the test strip (the open end is composed of the first and second rubber samples which are separated by the Mylar film so that a significant portion of the rubber samples are not cured together) are pulled apart to | | | | | |
| # expose open ends of each of the rubber samples and the exposed Mylar film strip is cut off. | | | | | |
| # The pulled-apart ends of the samples are placed into grips of the Instron test machine. The peel adhesion (tear strength) test is conducted at a crosshead speed of the Instron instrument at a of rate of 500 mm/min (20 inches/min) at 95° C. The force to pull apart the portion of the | | | | | |
| # samples cured together within the aforesaid Mylar window is obtained from the data under the load deflection curve reported by the Instron instrument and is expressed as N-cm. | | | | | |
| ⁴Data obtained according to Rubber Process Analyzer as RPA 2000 ™ instrument by Alpha Technologies, formerly the Flexsys Company and formerly the Monsanto Company. References to an RPA-2000 instrument may be found in the following publications: H. A. Palowski, et al, | | | | | |
| # Rubber World, June 1992 and January 1997, as well as Rubber & Plastics News, Apr. 26 and May 10, 1993. | | | | | |
| From Table 2 it can be seen that creation of the phase mixed natural rubber-rich rubber composition prepared by delaying addition of a portion of the natural rubber (and rubber reinforcing carbon black) to the first formed masterbatch until the second non-productive mixing stage (NP2), | | | | | |
| # particularly at the 10 or 20 phr of natural rubber level, (Samples E-1 and E-2 as compared to Control Sample C-2) effectively improved tear resistance properties of the resultant rubber composition at both 23° C. and 95° C. At the 30 phr of natural rubber addition level, (Sample E-3 as compared to the Control Sample | | | | | |
| # C-2) the tear resistance properties were slightly lower. The remaining indicated important physical properties of Samples E-1, E-2 and E-3 were not significantly changed as compared to Control Sample C-2. | | | | | |

### EXAMPLE III

### Comparative Example

Additional experiments were conducted to evaluate partially individually replacing natural rubber with emulsion polymerization prepared styrene/butadiene (E-SBR) and with cis 1,4-polybutadiene (BR) elastomers instead of the specialized trans 1,4-styrene/butadiene rubber of Example I.

The rubber compositions were prepared in the manner of Example II. Comparative Sample C-3 and Control Sample C-4 are prepared in the manner of Comparative C-1 and Control Sample C-2, respectively, of Example II. Experimental Samples E-4 and E-5 are prepared in the manner of the Samples E-1 and E-2, respectively, of Example II in a sense of partially replacing the natural rubber with the E-SBR and BR elastomers by the process of delayed natural rubber addition/masterbatch preparation, instead of addition of the specialized styrene/butadiene elastomer.

The basic recipe for the rubber samples is presented in Table 4.

TABLE 4

| | Parts by Weight |
|---|---|
| First Non-Productive Mixing Step (NP1) | |
| Natural cis 1,4-polyisoprene rubber, TSR20 | 55, 65, 75 or 100 |
| E-SBR rubber^{1A} | 15 |
| BR^{1B} | 10 |
| Carbon black² | 40 |
| Wax and Fatty acid³ | 3.5 |
| Zinc oxide | 4 |
| Second Non-Productive Mixing Step (NP2) | |
| Natural cis 1,4-polyisoprene rubber, TSR20 | 0, 10 or 20 |
| Carbon black² | 13 |
| Antioxidants⁴ | 3.5 |
| Productive Mixing Step (P) | |
| Sulfur | 1 |
| Accelerator⁵ | 1.5 |
| Retarder⁶ | 0.35 |
| Antioxidant⁴ | 0.5 |

Note:
Footnotes for Table 4 are the same as the footnotes for Table 2 except that footnotes 1A and 1B of Table 4 replace footnote 1 of Table 2 to reflect the partial replacement of the natural rubber with the E-SBR and BR elastomers instead of the specialized trans 1,4-styrene/butadiene elastomer.
^{1A}An emulsion polymerization prepared styrene/butadiene copolymer elastomer obtained as PLF1502 from The Goodyear Tire & Rubber Company having a bound styrene content of about 23.5 percent.
^{1B}An organic solvent solution polymerization prepared cis 1,4-polybutadiene elastomer obtained as BUD1207 from The Goodyear Tire & Rubber Company.

The following Table 5 illustrates cure behavior and various physical properties of the natural rubber-rich rubber compositions based upon the basic recipe of Table 4. Where cured rubber samples are evaluated, such as for the stress-strain, rebound, hardness and tear strength properties, the rubber samples were cured for about 32 minutes at a temperature of about 150° C.

TABLE 5

| | Comparative Control | | | |
|---|---|---|---|---|
| Sample | C-3 | C-4 | E-4 | E-5 |
| Rubber Compound (Cpd) | | | | |
| Natural cis | 100 | 75 | 65 | 55 |
| 1,4-polyisoprene | | | | |
| rubber (NP1) | | | | |
| Emulsion SBR | 0 | 15 | 15 | 15 |
| Cis-1,4-polybutadiene | 0 | 10 | 10 | 10 |
| Natural cis | 0 | 0 | 10 | 20 |
| 1,4-polyisoprene | | | | |
| rubber (NP2) | | | | |
| Rheometer, 150° C. | | | | |
| (MDR)¹ | | | | |
| Maximum torque (dNm) | 19.44 | 19.71 | 20.1 | 20.23 |
| Minimum torque (dNm) | 3.72 | 4.27 | 4.26 | 4.26 |
| Delta torque (dNm) | 15.72 | 15.44 | 15.84 | 15.97 |
| T90, minutes | 11.8 | 15.5 | 15.4 | 15.3 |
| Stress-strain (ATS)² | | | | |
| Tensile strength (MPa) | 23.4 | 22.8 | 22.9 | 23.5 |
| Elongation at break (%) | 496 | 504 | 504 | 511 |
| 300% modulus (ring) | 12.1 | 11.3 | 11.4 | 11.5 |
| (MPa) | | | | |
| Rebound | | | | |
| 23° C. | 41 | 42 | 41 | 41 |
| 100° C. | 54 | 55 | 54 | 54 |
| Hardness (Shore A) | | | | |
| 23° C. | 70 | 71 | 72 | 71 |
| 100° C. | 60 | 60 | 61 | 61 |
| Tear strength, N³ | | | | |
| 23° C.³ | 549 | 477 | 418 | 441 |
| 95° C. | 223 | 194 | 198 | 179 |
| RPA, 100° C., | | | | |
| 1 Hz⁴ | | | | |
| G′, at 10% | 1386 | 1484 | 1500 | 1535 |
| strain (kPa) | | | | |
| Tan delta at 10% strain | 0.166 | 0.158 | 0.154 | 0.151 |

Note:
Footnotes for the above Table 5 are the same as the footnotes for Table 3.

From Table 5 it can be seen that no improvement of tear strength is observed for Samples E-4 and E-5, as compared to Control Sample C-4 when the delayed process of natural rubber is used and the additional elastomers are an emulsion polymerization prepared styrene/butadiene copolymer elastomer (E-SBR) and a cis 1,4-polybutadiene rubber.

While certain representative embodiments and details have been shown for the purpose of illustrating the invention, it will be apparent to those skilled in this art that various changes and modifications may be made therein without departing from the spirit or scope of the invention.

1. A process of preparing a dual phased natural rubber-rich rubber composition which comprises, based upon parts by weight per 100 parts by weight rubber of said rubber composition (phr):
(A) blending in a preparatory mixing step to a temperature in a range of from about 140° C. to about 170° C. in an internal rubber mixer to form a masterbatch thereof, as a first phase of said natural rubber-rich rubber composition:
(1) about 50 to about 90 phr of a portion of and less than a total of from about 55 to about 98 phr of natural cis 1,4-polyisoprene rubber,
(2) about 2 to about 45 phr of specialized trans 1,4-styrene/butadiene copolymer elastomer, and
(3) about 25 to about 100 percent and thereby at least a portion of a total of 30 to about 120 phr of particulate reinforcing filler, and thereafter
(B) blending with said masterbatch in a subsequent additional preparatory mixing step to a temperature in a range of from about 140° C. to about 170° C. in an internal rubber mixer to form a resultant mixture thereof as a second phase of said natural rubber-rich rubber composition,
(1) the remainder of said 55 to about 98 phr of said natural cis 1,4-polyisoprene rubber not blended in said preparatory mixing step, and
(2) the remainder of said reinforcing filler not blended in said preparatory mixing step, if any, and thereafter
(C) blending sulfur curative with said resultant mixture to a temperature in a range of from about 90° C. to about 120° C. in an internal rubber mixer to form a resultant rubber composition;
wherein said masterbatch and said resultant mixture are individually removed from their associated internal rubber mixer and cooled to a temperature below 50° C. prior to the next sequential mixing step;
wherein said specialized styrene/butadiene copolymer elastomer has a bound styrene content in a range of from about 5 to about 40 percent and a microstructure of its polybutadiene portion composed of from about 50 to about 80 percent trans 1,4-isomeric units, from about 10 to about 20 percent cis 1,4-isomeric units and from about 2 to about 10 percent vinyl 1,2-isomeric units;
wherein said particulate reinforcing filler is comprised of:
(1) about 5 to about 120 phr of rubber reinforcing carbon black, and
(2) from zero to about 60 phr of amorphous synthetic precipitated silica.

2. (canceled)

3. (canceled)

4. (canceled)

5. (canceled)

6. (canceled)

7. The process of claim 1 which further comprises mixing a total of from zero to about 20 phr of at least one additional synthetic diene-based elastomer therewith as apportioned between said masterbatch and said resulting mixture, in at least one of said preparatory mixing steps, so long as said natural cis 1,4-polyisoprene rubber content of said rubber composition is at least 55 phr, selected from polymers of isoprene and/or 1,3-butadiene (in addition to said specialized trans 1,4-styrene/butadiene rubber) and copolymers of styrene together with isoprene and/or 1,3-butadiene.

8. The process of claim 1 which further comprises sulfur curing said rubber composition.

9. The process of claim 8 wherein said rubber composition is sulfur cured at a temperature in a range of from about 135° C. to about 170° C.

10. A rubber composition prepared by the process of claim 1.

11. A rubber composition prepared by the process of claim 8.

12. The process of claim 1 which further comprises extruding said rubber composition through a rubber extruder to form an unvulcanized rubber tread strip, building said unvulcanized rubber strip onto an unvulcanized rubber tire carcass to form an assembly thereof and curing said assembly in a suitable mold to form a tire.

13. A tire prepared by the process of claim 12.

14. (canceled)

15. A dual phased rubber composition prepared by the process of claim 1.

16. The process of claim 1 of preparing a natural rubber-rich rubber composition which comprises, based upon parts by weight per 100 parts by weight rubber of said rubber composition (phr):
(A) blending in a preparatory mixing step to form a masterbatch thereof:
(1) about 45 to about 85 phr of a portion of and less than a total of from about 60 to about 95 phr of natural cis 1,4-polyisoprene rubber,
(2) about 5 to about 40 phr of specialized trans 1,4-styrene/butadiene copolymer elastomer, and
(3) about 25 to about 100 percent of at least a portion of a total of 30 to about 120 phr of particulate reinforcing filler, thereafter
(B) blending with said masterbatch in a subsequent additional preparatory mixing step to form a resultant mixture thereof,
(1) the remainder of said 60 to about 95 phr of said natural cis 1,4-polyisoprene rubber not blended in said preparatory mixing step, and
(2) the remainder of said 30 to about 120 phr of said reinforcing filler not blended in said preparatory mixing step, if any, and thereafter
(C) blending a sulfur curative with said resultant mixture to form a resultant rubber composition;
wherein said specialized styrene/butadiene copolymer elastomer has a bound styrene content in a range of from about 15 to 30, percent and a microstructure of its polybutadiene portion composed of from about 50 to about 80 percent trans 1,4-isomeric units, from about 10 to about 20 percent cis 1,4-isomeric units and from about 2 to about 10 percent vinyl 1,2-isomeric units;
wherein said particulate reinforcing filler is comprised of:
(1) about 5 to about 120 phr of rubber reinforcing carbon black, and
(2) from about 5 to about 60 phr of amorphous synthetic precipitated silica together with a coupling agent for said precipitated silica having a moiety reactive with hydroxyl groups on said precipitated silica and another different moiety interactive with said natural cis 1,4-polybutadiene rubber and said specialized trans 1,4-styrene/butadiene copolymer elastomer.

17. (canceled)

18. The process of claim 16 wherein said coupling agent for said precipitated silica is a bis(3-trialkylsilylalkyl) polysulfide which contains an average of from about 2.3 to about 4 sulfur atoms in its polysulfidic bridge or an alkoxyorganomercaptosilane.

19. The process of claim 16 which further comprises extruding said rubber composition through a rubber extruder to form an unvulcanized rubber tread strip, building said unvulcanized rubber strip onto an unvulcanized rubber tire carcass to form an assembly thereof and curing said assembly in a suitable mold to form a tire.

20. A tire prepared by the process of claim 19.

21. The process of claim 7 which further comprises sulfur curing said rubber composition.

22. A rubber composition prepared by the process of claim 21.
